(19) United States
(12) Patent Application Publication
(10) Pub. No.: US 2019/0213215 A1
(43) Pub. Date: Jul. 11, 2019

(54) METHOD AND DEVICE FOR CONTINUING A RUNNING PLAYBACK OF AUDIO AND/OR VIDEO CONTENT FROM A FIRST SOURCE AFTER A TEMPORARY INTERRUPTION OR OVERLAYING THE RUNNING PLAYBACK BY A PLAYBACK OF AUDIO AND/OR VIDEO CONTENT FROM A SECOND SOURCE

(71) Applicant: Continental Automotive GmbH, Hannover (DE)

(72) Inventor: Karsten RUECKER, Asslar (DE)

(21) Appl. No.: 16/306,016

(22) PCT Filed: May 18, 2017
(86) PCT No.: PCT/EP2017/061988

§ 371 Date: Nov. 30, 2018

(30) Foreign Application Priority Data
May 30, 2016 (DE) 10 2016 209 279.0

(51) Int. Cl. G06F 16/783; G06F 16/683; H04N 21/432; G10L 15/05; G10L 15/26; G10L 21/055

(52) U.S. Cl. CPC G06F 16/7834; G06F 16/685; G10L 21/055; G10L 15/05; G10L 15/265; H04N 21/4325

(57) ABSTRACT

A method for continuing an ongoing reproduction of audio and/or video content from a first source after a temporary interruption to or overlay on the ongoing reproduction by a reproduction of audio and/or video content from a second source comprises storing a first time marking the beginning of an interruption to or overlay on the ongoing reproduction of the audio and/or video content from the first source with a reproduction of audio and/or video content from a second source. If the first source provides audio and/or video content received and reproduced substantially in real time, the received audio and/or video content is recorded at least from the first time onward. The end of the interruption or overlay is detected, and audio and/or video content from the first source or the recording is reproduced from a point consistent with the first time.

### BACKGROUND

### Technical Field

The present invention relates to the reproduction of audio and/or video content after temporary interruptions to or overlays on an ongoing reproduction by other audio and/or video content.

### Prior Art

An ongoing reproduction of audio and/or video content provided by a first source can be interrupted, in particular in the setting of infotainment systems arranged in vehicles, on the basis of different events. By way of example, an ongoing radio program received and reproduced by a radio receiver as a first source can be interrupted by an announcement from a navigation system. In this case, the navigation system is a second source, and the announcement is an audio content from the second source. Interruptions to ongoing reproductions of audio and/or video content can alternatively come from other second sources, for example from an incoming telephone call. In that case, the cell phone is the second source, and the ringtone or the conversation itself are an audio content from the second source. It is irrelevant in this context whether the cell phone is permanently connected to the infotainment system or whether it is connected to the infotainment system by means of a cable or a wireless connection. Another second source could be a system component that transmits a signal tone indicating a state or an action of the system or pointing out a hazard situation.

The interruption is usually effected by switching the reproduction of audio and/or video content from the first source to the second source, for example for the duration of a navigation announcement or a phone call, and subsequently switching back to the first source.

FIG. 1 shows a first exemplary sequence for the audio output from the infotainment system known from the prior art over time. Up to the time t1, the audio signal from the first source Q1 is reproduced. From the time t1 to the time t2, the audio signal from the second source Q2 is reproduced. From the time t2 onward, the signal from the first source Q1 is then reproduced again. Since the content of the signal from the first source Q1 goes on continuously, but the signal from the first source Q1 is not reproduced in the time between t1 and t2, the listener cannot hear the content provided by the first source Q1 between t1 and t2, and he thus misses the content provided by the first source Q1 in this time (depicted by the black area in the figure).

In some infotainment systems, there is no abrupt switching between the first and second sources or the second source and the first source, but rather a continuous lowering of the volume takes place, either down to a lower volume in comparison with the previously set volume or until the audio signal is no longer audible or the audio signal level is zero. Accordingly, the volume of the signal reproduced from the second source during the interruption can be continuously raised to a preset or user-selected volume value, this raising not being necessary, depending on the type of the second source and of the signals, for example if a voice output from a navigation system does not begin until the audio signal from the first source is sufficiently quiet. The lowering of the volume of the audio signal from the first source and the raising of the volume of the audio signal from the second source can, depending on the application of the first and second sources, be effected wholly or partially at the same time, that is to say in overlapping fashion.

In the case of video signals, it is accordingly possible for one video signal to be faded out and the other video signal to be faded in, for example by means of what is known as a fade to black or by means of what is known as alpha blending. A fade to black involves the brightness of the video signal being decreased until the video image is black. Alpha blending involves the video signal becoming ever more transparent until finally it can no longer be seen. Alpha blending is particularly suitable for fading in one video signal and fading out the other video signal at the same time.

Particularly in the case of fade-in and fade-out processes, the problem arises that the content can no longer be heard from a particular volume value of an audio signal downward or can no longer be seen from a particular brightness of a video signal downward. Even if reproduction of a recording is stopped at the end of a fade-out process, parts of the content are thus no longer audible. The same problem arises for fade-in, where content can be heard or seen again only from a particular volume value or a particular brightness upward. The respective brightness and volume values are furthermore individually different.

FIG. 2 shows a second exemplary sequence for the audio output from an infotainment system known from the prior art over time. Up to the time t1, the audio signal from the first source Q1 is reproduced at the previously set volume. At this time, a second source Q2 signals that an interruption to the output of the signal from the first source Q1 is imminent in order to reproduce the signal from the second source Q2. At the same time, a progressive reduction in the volume of the reproduction of the audio signal from the first source Q1 begins, which is finished at the time t1“. From a particular reduction in the volume of the signal from the first source Q1 onward, which is reached at the time t1′, the content of the signal from the first source Q1 can no longer be understood. At the time t1”, reproduction of the signal from the second source Q2 then begins, which lasts until the time t2. From this time onward, the audio signal from the first source Q1 is then reproduced again. When the audio output is switched to the signal from the first source Q1, a progressive increase in the volume of the reproduction of the audio signal from the first source Q1 to a value that was set before the interruption is effected, which is finished at the time t2″. Only from a particular volume upward, which is reached at the time t2′, is it possible for the content of the signal from the first source Q1 to be understood again. Since the content of the signal from the first source Q1 goes on continuously, but the signal from the first source Q1 cannot be understood or is not reproduced in the time between t1′ and t2′, the listener cannot hear the content provided by the first source Q1 between t1′ and t2′, and he thus misses the content provided by the first source Q1 in this time. The fade-out and fade-in mean that the listener even misses more content than he would miss if the sources were switched abruptly.

Other first sources comprise playback apparatuses for audio and/or video content stored on data storage media, that is to say for example CD players or DVD players, media playback apparatuses or programs for reproducing audio and/or video content stored on mass memories permanently or temporarily communicatively connected to the infotainment system, and the like.

If another first source of this kind reproduces a local recording, reproduction of the local recording can be stopped for the duration of the interruption, for example a CD player can be put into a pause mode. After the end of the interruption, reproduction is continued at the point at which it was interrupted. An exemplary sequence for the audio output from an infotainment system known from the prior art over time for this instance of application is shown in FIG. 3. The ongoing reproduction of the first source Q1 is paused at the time t1, depicted by the “pause” symbol 302, and the signal from the second source Q2 is reproduced. At the time t2, reproduction of the signal from the second source Q2 is terminated and reproduction of the signal from the first source Q1 is continued, depicted by the “play” symbol 304. In this case, the listener misses no content, but, depending on the duration of the interruption, it may be irritating if the reproduction of audiobooks, for example, has been interrupted mid-sentence or mid-word.

The irritation can be perceived as even greater if reproduction is not paused until after a fade-out process and a fade-in process is continued, because, in this case, the result may be that quiet passages are not understood during fade-out and fade-in. An exemplary sequence for the audio output from an infotainment system known from the prior art over time for a situation of this kind is depicted by way of example in FIG. 4. Up to the time t1, the audio signal from the first source Q1 is reproduced at the previously set volume. At this time, a second source Q2 signals that an interruption to the output of the signal from the first source Q1 is imminent in order to reproduce the signal from the second source Q2. At the same time, a progressive reduction in the volume of the reproduction of the audio signal from the first source Q1 begins, which is finished at the time t1“. From a particular reduction in the volume of the signal from the first source Q1 onward, which is reached at the time t1′, the content of the signal from the first source Q1 can no longer be understood. At the time t1”, reproduction of the first source Q1 is paused, depicted by the “pause” symbol 302, and reproduction of the signal from the second source Q2, which lasts until the time t2, begins. From this time onward, the audio signal from the first source Q1 is then reproduced again, depicted by the “play” symbol 304. When reproduction of the signal from the first source Q1 continues, a progressive increase in the volume of the reproduction of the audio signal from the first source Q1 to a value that was set before the interruption is effected, which is finished at the time t2″. Only from a particular volume upward, which is reached at the time t2′, is it possible for the content of the signal from the first source Q1 to be understood again. Between the times t1′ and t1″ and also t2′ and t2″, the content of the signal from the first source Q1 may possibly not be understood.

The possibly equally irritating effects of fade-in and fade-out processes for the signal from the second source Q2 analogously to the effects described with reference to the signals from the first source Q1 are not depicted in the figure.

In some infotainment systems, the first source is faded out and the second source is faded in with an overlap. An exemplary sequence for a signal output for this case is shown in FIG. 5, but will not be explained in more detail below, because the effects and disadvantages are similar to those of the example described with reference to FIG. 4.

Fundamentally, if the first source is a radio receiver or a receiver for what are known as streaming media, that is to say for audio or video sources that, similarly to a radio broadcast, are transmitted in a digital communication network to one or more appropriate receivers, then the program content transmitted or streamed during the interruption cannot be listened to, because at the end of the interruption there is usually only a switch back to the program, which continues during the interruption. Usually, no significant storage of the received content beyond the minimum extent necessary for interruption-free reproduction takes place either.

The term “interruption” is used synonymously with “overlay” in this description. An overlay exists when the volume of an audio signal or the brightness or visibility of a video signal from a first source is reduced to such an extent that a louder audio signal or a brighter or more visible video signal from a second source is heard or seen more clearly or alone. Within the context of this description, the term interruption likewise covers a temporary stoppage of the reproduction of a first source without a second source being reproduced after the stoppage, for example if the reproduction of an audiobook is paused in order to talk to a passenger and subsequently the reproduction of the audiobook is continued.

### BRIEF SUMMARY

It is an object of the invention to specify a method and an apparatus that improve the ability of content from a first source to be heard or seen after a temporary interruption to the reproduction, e.g. by a reproduction of content from a second source.

The object is achieved by the method specified in claim 1 and the apparatus specified in claim 9. Advantageous refinements and further developments of the method and apparatus are specified in corresponding dependent claims.

According to one aspect of the invention, to continue an ongoing reproduction of audio and/or video content from a first source after a temporary interruption to the ongoing reproduction, e.g. by an exclusive or overlaid reproduction of audio and/or video content from a second source, but also without reproduction of signals from a second source during the interruption, a first time is stored that marks the beginning of an interruption to or overlay on the ongoing reproduction of the audio and/or video content from the first source with a reproduction of audio and/or video content from a second source. If the source provides audio and/or video content received and reproduced substantially in real time, the received audio and/or video content is recorded at least from the first time onward. Buffering of a small quantity of signals representing the received audio and/or video content, e.g. in order to ensure interruption-free reproduction in the event of smaller disruptions to the reception path too, is not intended to be regarded as recording within the context of the invention in this case. Reception and reproduction in real time means that respectively received signals are reproduced immediately after reception apart from a delay due to signal processing in a receiver that is necessary before reproduction. After an end of the interruption or overlay by the audio and/or video content from the second source has been detected, reproduction of the recorded audio and/or video content from the first source or the recording thereof is continued at a point consistent with the first time. Continuation of reproduction “at a point consistent with the first time” in this context means that reproduction is continued with the audio and/or video content that would have been reproduced at the first time without the presence of the interruption or overlay. The recording of signals from a first source providing audio and/or video content received and reproduced substantially in real time is continued during reproduction, which means that there is a time offset between the received and reproduced content.

According to one aspect of the invention, if the source provides audio and/or video content received and reproduced substantially in real time, reproduction is effected at a reproduction speed that is increased in comparison with a reproduction in real time. A resultant frequency shift in audio signals toward higher frequencies can be compensated for by means of appropriate processing of the signals, e.g. by means of a digital signal processor set up for frequency correction. In the case of video content, reproduction can be speeded up e.g. by omitting individual frames at regular intervals. From a particular time onward, which is dependent on the duration of the recording and the speed of playback, reproduction and reception are then in sync again, and the first source can be reproduced again without interim recording.

According to one aspect of the invention, detection is performed for the audio and/or video content from the first source to determine whether it substantially contains speech content or speech information. Only in the positive case is the received audio and/or video content recorded for a later reproduction. This aspect of the invention takes into consideration that an interruption to speech content is normally perceived as irritating to a greater extent than an interruption to music content. When this aspect is implemented in an apparatus for performing the method according to the invention, this option may be activable by a user selectively.

According to one aspect of the invention, if the first source provides audio and/or video content received and reproduced substantially in real time, a quantity of signals from the first source that is consistent with a first reproduction duration is continuously recorded in a ring buffer, even if no interruption or overlay by signals from the second source has been detected. When a recording of the audio/or video signals from the first source is triggered by an interruption or overlay, the content of the ring buffer is placed at the front of the recording, and reproduction of the recording after the end of the interruption or overlay is begun with the content of the ring buffer. This aspect allows a return to before the first time, which marks the beginning of the recording. In particular in the case of longer interruptions, this may be advantageous, e.g. if the first source delivers predominantly speech content: In this case, a sentence that has already been started can be reproduced in full once more, which means that the listener does not have to remember the part of the sentence that was before the interruption. The return can also be made just conditionally, e.g. only if the recording substantially contains speech information. It is also possible to return only to a point from which speech information is contained in the recording. The last aspect allows received and recorded speech content still to be heard during a longer interruption or overlay, for example if a message transmission begins during an interruption for an announcement from a navigation system or for a phone call, or a traffic radio announcement is received. An applicable analysis can be performed during the actual interruption to or reproduction of the signal from the second source.

In the case of a similar aspect of the invention, if the first source is available on a locally accessible data storage medium as a recording anyway, reproduction is begun at a time in the recording that is before the first time. If, by way of example, the first source reproduces a recording of a radio play, an interruption or overlay by a signal from the second source can be followed by a return to the start of the chapter. The length of time over which the recording is returned to may be prescribed or may be adjustable by a user, but may also be dependent on the length of individual chapters, or on the point within the chapter at which the interruption or overlay occurred. As such, if the chapter is relatively long, for example three minutes, a return to the start of the chapter would be more likely to be irritating if the interruption or overlay by the signal from the second source occurred a few seconds before the end of the chapter.

In the case of one aspect of the invention, reproduction of a recorded audio and/or video content can be terminated by a user input, in which case undelayed reproduction of a received signal is effected. This aspect may be advantageous if, at the time of the interruption or during the interruption, radio advertising with a high proportion of speech or a moderation that is of no interest has been received.

Speech recognition can be effected in a conventional way, for example by means of an apparatus or a piece of software for speech recognition, and also by means of an identifier or flag contained in the signal from the first source, by means of a frequency analysis for the signal or by means of analysis of a piece of auxiliary information transmitted with the audio/video signal. Auxiliary information of this kind can comprise a piece of title information, for example, indicating a piece of music or an audiobook, or subtitles transmitted with a video content, or the like.

Various aspects that have each been presented separately above can be combined. As such, by way of example, fade-in and fade-out can be combined with rewinding, or rewinding within a content that is available as a recording anyway is effected only if the content is formed predominantly by speech, but not in the case of music.

An apparatus for continuing an ongoing reproduction of audio and/or video content from a first source after a temporary interruption to or overlay on the ongoing reproduction by a reproduction of audio and/or video content from a second source comprises an interface for actuating at least one loudspeaker for reproducing audio content and/or for actuating at least one display for reproducing video content. The apparatus additionally comprises a microprocessor, main memory and nonvolatile memory, and also an interface for accessing means for locally storing audio and/or video content. The components of the apparatus are communicatively connected to one another by means of one or more data lines and/or data buses for transmitting data and/or control signals. The non-volatile memory contains computer program instructions that, when executed by the microprocessor during access to the main memory, carry out the method steps of one or more of the aforementioned aspects of the invention.

In the case of one or more aspects of the invention, the apparatus additionally has means for recognising speech by means of analysis of audio content, and/or means for recognising speech by means of analysis of secondary features of audio and/or video content. Secondary features in this context comprise titles or additional text information linked to the content, subtitles of video content, and the like.

### BRIEF DESCRIPTION OF THE DRAWINGS

Aspects of the invention will be described below with reference to the drawing. In the drawing:

FIG. 1 shows a first schematic depiction of a reproduction of a signal from a first source that is interrupted by a signal from a second source, based on the prior art,

FIG. 2 shows a second schematic depiction of a reproduction of a signal from a first source that is interrupted by a signal from a second source, based on the prior art,

FIG. 3 shows a third schematic depiction of a reproduction of a signal from a first source that is interrupted by a signal from a second source, based on the prior art,

FIG. 4 shows a fourth schematic depiction of a reproduction of a signal from a first source that is interrupted by a signal from a second source, based on the prior art,

FIG. 5 shows a fifth schematic depiction of a reproduction of a signal from a first source that is interrupted by a signal from a second source, based on the prior art,

FIG. 6 shows a schematic depiction of a reproduction of a signal from a first source that is interrupted by a signal from a second source, based on a first aspect of the invention,

FIG. 7 shows a schematic depiction of a reproduction of a signal from a first source that is interrupted by a signal from a second source, based on a second aspect of the invention,

FIG. 8 shows a schematic depiction of a reproduction of a signal from a first source that is interrupted by a signal from a second source, based on a third aspect of the invention,

FIG. 9 shows a schematic depiction of a reproduction of a signal from a first source that is interrupted by a signal from a second source, based on a fourth aspect of the invention,

FIG. 10 shows a schematic depiction of a reproduction of a signal from a first source that is interrupted by a signal from a second source, based on a fifth aspect of the invention,

FIG. 11 shows a schematic depiction of a reproduction of a signal from a first source that is interrupted by a signal from a second source, based on a sixth aspect of the invention,

FIG. 12 shows a schematic depiction of a reproduction of a signal from a first source that is interrupted by a signal from a second source, based on a seventh aspect of the invention,

FIG. 13 shows an exemplary schematic block diagram of an aspect of the invention, and

FIG. 14 shows a simplified exemplary flowchart of an aspect of the invention.

### DETAILED DESCRIPTION

In the figures of the drawing, identical or similar elements are provided with identical reference signs.

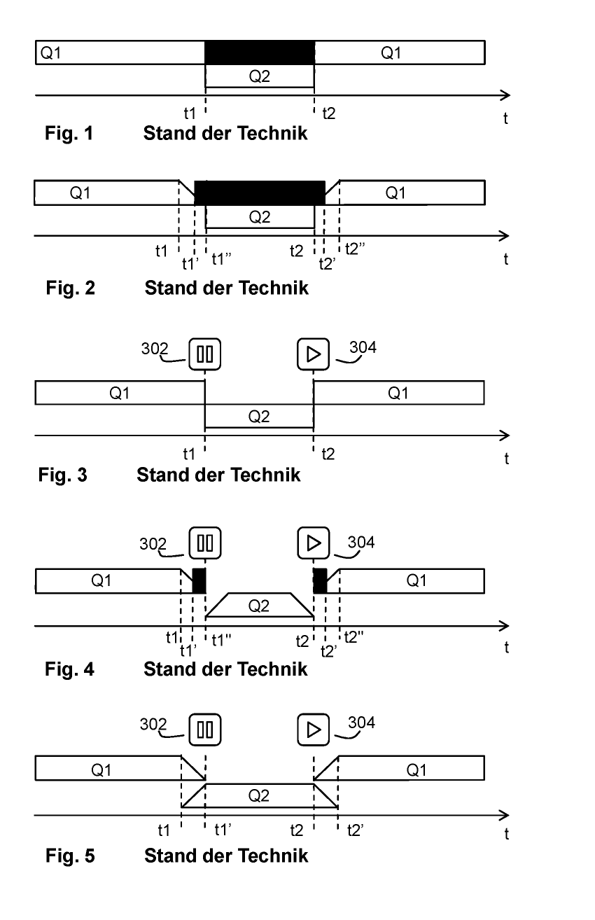

FIGS. 1 to 5, showing the prior art, have already been discussed in detail earlier on and are not explained again at this juncture.

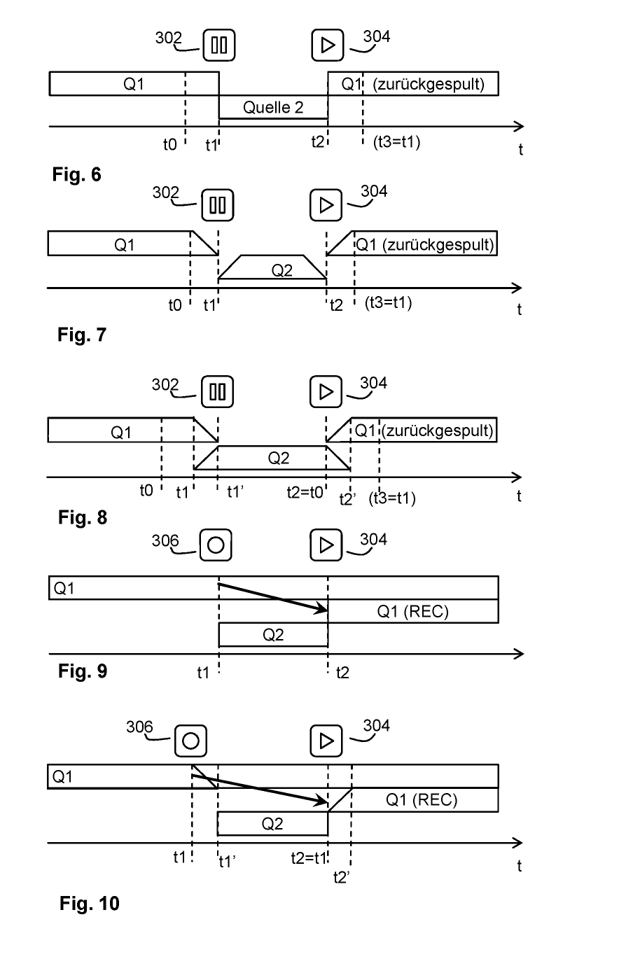

FIG. 6 shows a schematic depiction of a reproduction of a signal from a first source that is interrupted by a signal from a second source, based on a first aspect of the invention. Furthermore, the signal from the first source Q1 is reproduced. The first source Q1 is, by way of example, a reproduction device reproducing a locally accessible recording of an audio and/or video signal. At the time t1, reproduction of the signal from the first source Q1 is interrupted by reproduction of the signal from a second source Q2. In this case, reproduction of the signal from the first source is paused or stopped at the time t1, indicated by the “pause” symbol 302. As soon as reproduction of the signal from the second source Q2 is finished, at the time t2 in the figure, reproduction of the signal from the first source Q1 is continued, indicated by the “play” symbol 304. However, reproduction is effected not at the point that was reproduced at the time t1, but rather at a point that has already been reproduced beforehand at a time t0, which is before the time t1. At the time t2, the content of the signal from the first source Q1 that has already been reproduced beforehand at the time t0 is thus reproduced. Only at the time t3 is the point in the content of the signal from the first source Q1 that would have been reproduced without the interruption at the time t1 reproduced. Before reproduction is continued, the content of the signal from the source Q1 has thus been “rewound” more or less by the time difference t1−t0.

FIG. 7 shows a schematic depiction of a reproduction of a signal from a first source that is interrupted by a signal from a second source, based on a second aspect of the invention. As described with reference to FIG. 6, the signal from the first source Q1 is first of all reproduced. The first source Q1 is, by way of example, a reproduction device reproducing a locally accessible recording of an audio and/or video signal. At the time Ti, reproduction of the signal from the first source Q1 is interrupted after a fade-out process by reproduction of the signal from a second source Q2, which begins with a fade-in process. In this case, reproduction of the signal from the first source is paused or stopped at the time t1, indicated by the “pause” symbol 302. As soon as reproduction of the signal from the second source Q2 is finished after a fade-out process, at the time t2 in the figure, reproduction of the signal from the first source Q1 is continued with a fade-in process, indicated by the “play” symbol 304. The fade-in and fade-out processes are indicated by the sloping edges of the bars depicting the sources. As in the example explained with reference to FIG. 6, reproduction is continued not at the point that was reproduced at the time t1, however, but rather at a point that has already been reproduced beforehand at a time t0, which is before the time t1. At the time t2, the content of the signal from the first source Q1 that has already been reproduced beforehand at the time t0 is thus reproduced. Only at the time t3 is the point in the content of the signal from the first source Q1 that would have been reproduced without the interruption at the time t1 reproduced. Before reproduction is continued, the content of the signal from the source Q1 has thus been “rewound” more or less by the time difference t1−t0. In this example, the content of the first source has thus been reproduced twice at least during the respective fade-out and fade-in processes, so that overall no part of the content from the first source evades being heard or seen by a user as a result of the fade-in and fade-out processes.

FIG. 8 shows a schematic depiction of a reproduction of a signal from a first source that is interrupted by a signal from a second source, based on a third aspect of the invention. At the time t1, an interruption to the reproduction of the signal from the first source Q1 is initiated with a fade-out process. At the same time, a fade-in process for the signal from the second source is performed. The fade-in and fade-out processes are finished at the time t1′ interrupted by reproduction of the signal from a second source Q2, which begins with a fade-in process. At the end of the interruption, a corresponding fade-out and fade-in process is effected between t2 and t2′. In this case, as in the example described with reference to FIG. 7, reproduction of the signal from the first source at the time t2 is continued not at the point at which the fade-out process began, but rather at an earlier point that was reproduced at the time t0. In this example, even more of the content of the signal from the first source Q1 is repeated than as a result of the fade-out and fade-in processes. The “rewinding” can be effected, by way of example, to the start of a chapter of an audiobook or to a start of a sentence interrupted by the interruption, which means that the whole sentence or the whole chapter can be heard without interruption.

FIG. 9 shows a schematic depiction of a reproduction of a signal from a first source that is interrupted by a signal from a second source, based on a fourth aspect of the invention. First of all, the signal from the first source Q1, which provides audio and/or video content received and reproduced substantially in real time, is reproduced. At the time t1, reproduction of the signal from the first source Q1 is interrupted by reproduction of the signal from a second source Q2. From this time onward, the signal from the first source is recorded, indicated by the “record” symbol 306. As soon as reproduction of the signal from the second source Q2 is finished, at the time t2 in the figure, reproduction of the signal from the first source Q1 is continued, indicated by the “play” symbol 304. In this case, reproduction is continued from the beginning of the recording, indicated by the source label “Q1 (REC)”. Recording of the signals from the first source continues in this case, by way of example, until a command to stop the recording is received, or until a user selects a different source for reproduction.

FIG. 10 shows a schematic depiction of a reproduction of a signal from a first source that is interrupted by a signal from a second source, based on a fifth aspect of the invention. The initial situation is similar to that of FIG. 9, but before reproduction of the first source is switched to reproduction of the second source, a fade-out process takes place between t1 and t1′, and corresponding fade-out and fade-in processes take place at the end of the interruption between t2 and t2′. As described earlier on with reference to the prior art, it is possible that content may no longer or not yet be heard or seen from a particular time onward during the fade-out or fade-in process.

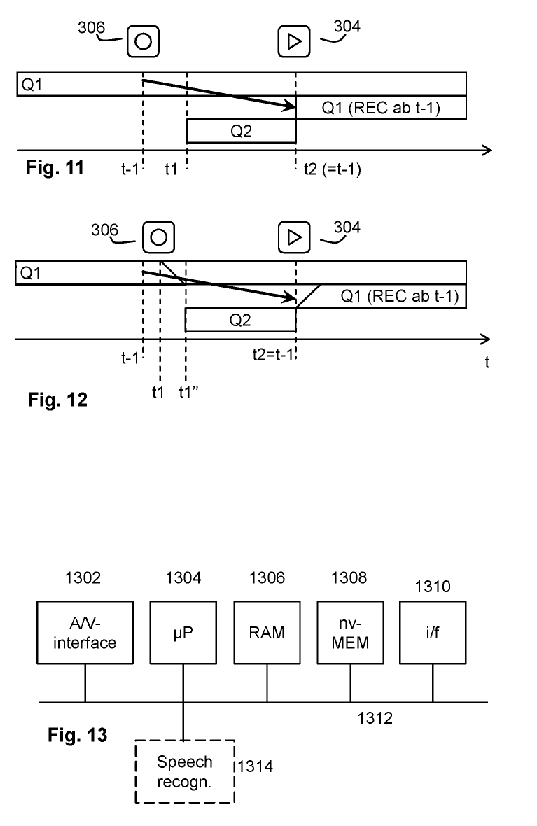

FIG. 11 shows a schematic depiction of a reproduction of a signal from a first source that is interrupted by a signal from a second source, based on a sixth aspect of the invention. The initial situation is consistent with that of FIG. 9, but the signal from the first source is continuously recorded in a ring memory, so that a certain period of time from the signal, in each case comprising a directly preceding period, is stored at each time. First of all, the signal from the first source Q1, which provides audio and/or video content received and reproduced substantially in real time, is reproduced. At the time t1, there is a switch to the second source Q2, reproduction of which is finished at the time t2. From the time t1 onward, the signal from the first source is recorded, indicated by the “record” symbol 306. The content that the ring memory contains from the first source, that is to say the period t−1 to t1, is placed at the front of the recording. As soon as reproduction of the signal from the second source Q2 is finished, at the time t2 in the figure, reproduction of the signal from the first source Q1 is continued, indicated by the “play” symbol 304. In this case, reproduction is continued from the beginning of the recording to which the content of the ring memory has been added, indicated by the source label “Q1 (REC from t−1)”. Recording of the signals from the first source continues in this case, by way of example, until a command to stop the recording is received, or until a user selects a different source for reproduction.

FIG. 12 shows a schematic depiction of a reproduction of a signal from a first source that is interrupted by a signal from a second source, based on a seventh aspect of the invention. The initial situation is consistent with that of FIG. 10, but the signal from the first source is continuously recorded in a ring memory, so that a certain period of time from the signal, in each case comprising a directly preceding period, is stored at each time. At the time t1, a fade-out process is initiated and reproduction of the signal from the first source Q1 is interrupted at the time t1′ by reproduction of the signal from a second source Q2. From the time t1 onward, the signal from the first source is recorded, indicated by the “record” symbol 306. The content that the ring memory contains from the first source is placed at the front of the recording. As soon as reproduction of the signal from the second source Q2 is finished, at the time t2 in the figure, reproduction of the signal from the first source Q1 is continued, indicated by the “play” symbol 304. In this case, reproduction is continued from the beginning of the recording to which the content of the ring memory has been added, indicated by the source label “Q1 (REC from t−1)”. Recording of the signals from the first source continues in this case, by way of example, until a command to stop the recording is received, or until a user selects a different source for reproduction. This example has the assurance that content situated in the area of the fade-in and fade-out that possibly can no longer be heard or seen completely at particular times during the fade-in and fade-out processes can be heard or seen with certainty as a result of the repetition.

FIG. 13 shows an exemplary schematic block diagram of an aspect of the invention. An interface 1302 for actuating at least one loudspeaker for reproducing audio content and/or for actuating at least one display for reproducing video content (not shown) is communicatively connected to a microprocessor 1304, main memory 1306 and nonvolatile memory 1308, an interface 1310 for accessing means for locally storing audio and/or video content (not shown) and an optional apparatus 1314 for recognising speech by means of one or more data lines and/or data buses 1312 for transmitting data and control signals. The non-volatile memory in this case contains computer program instructions that, when executed by the microprocessor during access to the main memory, carry out the method steps of one or more of the aforementioned aspects of the invention.

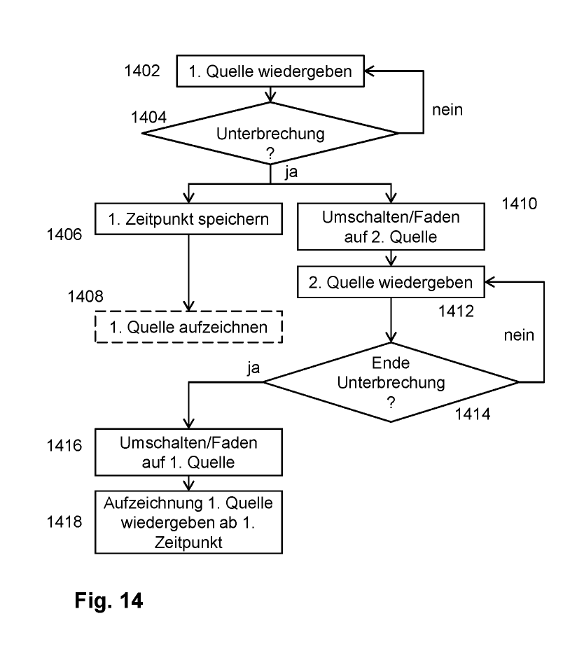

FIG. 14 shows a simplified exemplary flowchart of an aspect of the invention. In step 1402, the signal from the first source is reproduced, and in step 1404 a check is performed to determine whether an interruption is effected by reproduction of a signal from a second source. If not, “no” branch from step 1404, reproduction of the signal from the first source is continued. If there is an interruption, “yes” branch from step 1404, a first time is stored, step 1406, and optionally—indicated by the dashed border—the signal from the first source is recorded from the first time onward, step 1408. In parallel with this, there is a switch to reproduction of the second source, and appropriate fade-out and fade-in processes are carried out, in step 1410, and the second source is reproduced in step 1412. In step 1414, a check is performed to determine whether reproduction of the second source, that is to say the interruption, is at an end. If not, “no” branch from step 1414, reproduction of the second source is continued. If yes, “yes” branch from step 1414, there is a switch to reproduction of the first source, and appropriate fade-out and fade-in processes are carried out, in step 1416, and in step 1418 the first source or the recording of the first source is reproduced from the first time onward.

1. A method for continuing an ongoing reproduction of audio and/or video content from a first source after a temporary interruption to or overlay on the ongoing reproduction, comprising:
storing a first time marking the beginning of an interruption to or overlay on the ongoing reproduction of the audio and/or video content from the first source with a reproduction of audio and/or video content from a second source;
if the first source provides audio and/or video content received and reproduced substantially in real time,
detecting whether the audio and/or video content substantially contains speech information at least from the first time onward,
recording the received audio and/or video content at least from the first time onward if the audio and/or video content substantially contains speech content,
detecting the end of the interruption or overlay, and
reproducing the audio and/or video content from the first source or the recording at a point consistent with the first time.

2. The method as claimed in claim 1, wherein, if the first source provides audio and/or video content received and reproduced substantially in real time, a quantity of signals from the first source that is consistent with a first reproduction duration is continuously recorded in a ring buffer, said signals being placed at the front of the recording, and wherein reproduction of the recording after the end of the interruption or overlay is begun with the content of the ring buffer.

3. The method as claimed in claim 2, additionally comprising:
analysing the content of the recording for a linguistic syntax,
wherein the point in the recording that is before the first time, and from which reproduction is continued, is a start of a sentence interrupted by the interruption or overlay.

4. The method as claimed in claim 3, additionally comprising:
analysing the recording for the presence of speech content, and
reproducing the recording from the first source beginning at a point from which speech content is contained in the recording.

5. The method as claimed in claim 4, additionally comprising:
receiving a user input prompting reproduction of a recorded audio and/or video content to be terminated after the interruption or overlay, in which case undelayed reproduction of a received signal is effected.

6. The method as claimed in claim 5, wherein, if the first source provides audio and/or video content received and reproduced substantially in real time, the recording is continued during reproduction.

7. The method as claimed in claim 6, wherein reproduction of the recording is effected at an increased reproduction speed in comparison with a normal reproduction speed until a time at which the reproduced audio and/or video content is consistent with the audio and/or video content received.

8. An apparatus for continuing an ongoing reproduction of audio and/or video content from a first source after a temporary interruption to or overlay on the ongoing reproduction, comprising:
an interface for actuating at least one loudspeaker for reproducing audio content and/or for actuating at least one display for reproducing video content,
a microprocessor,
main memory,
nonvolatile memory,
an interface for accessing means for locally storing audio and/or video content that are communicatively connected to one another by means of one or more data lines and/or data buses for transmitting data and/or control signals, wherein the nonvolatile memory contains computer program instructions that, when executed by the microprocessor during access to the main memory, set up the apparatus to carry out operations comprising:
storing a first time marking the beginning of an interruption to or overlay on the ongoing reproduction of the audio and/or video content from the first source with a reproduction of audio and/or video content from a second source;
if the first source provides audio and/or video content received and reproduced substantially in real time,
detecting whether the audio and/or video content substantially contains speech information at least from the first time onward,
recording the received audio and/or video content at least from the first time onward if the audio and/or video content substantially contains speech content,
detecting the end of the interruption or overlay, and
reproducing the audio and/or video content from the first source or the recording at a point consistent with the first time.

9. The apparatus as claimed in claim 8, wherein, if the first source provides audio and/or video content received and reproduced substantially in real time, a quantity of signals from the first source that is consistent with a first reproduction duration is continuously recorded in a ring buffer, said signals being placed at the front of the recording, and wherein reproduction of the recording after the end of the interruption or overlay is begun with the content of the ring buffer.

10. The apparatus as claimed in claim 9, wherein the nonvolatile memory contains computer program instructions that, when executed by the microprocessor during access to the main memory, set up the apparatus to carry out further operations comprising:
analysing the content of the recording for a linguistic syntax,
wherein the point in the recording that is before the first time, and from which reproduction is continued, is a start of a sentence interrupted by the interruption or overlay.

11. The apparatus as claimed in claim 10, wherein the nonvolatile memory contains computer program instructions that, when executed by the microprocessor during access to the main memory, set up the apparatus to carry out further operations comprising:
analysing the recording for the presence of speech content, and
reproducing the recording from the first source beginning at a point from which speech content is contained in the recording.

12. The apparatus as claimed in claim 11, wherein the nonvolatile memory contains computer program instructions that, when executed by the microprocessor during access to the main memory, set up the apparatus to carry out further operations comprising:
receiving a user input prompting reproduction of a recorded audio and/or video content to be terminated after the interruption or overlay, in which case undelayed reproduction of a received signal is effected.

13. The apparatus as claimed in claim 12, wherein, if the first source provides audio and/or video content received and reproduced substantially in real time, the recording is continued during reproduction.

14. The apparatus as claimed in claim 13, wherein reproduction of the recording is effected at an increased reproduction speed in comparison with a normal reproduction speed until a time at which the reproduced audio and/or video content is consistent with the audio and/or video content received.
